(19) United States
(12) Patent Application Publication
(10) Pub. No.: US 2015/0312248 A1
(43) Pub. Date: Oct. 29, 2015

(54) IDENTITY AUTHENTICATION

(71) Applicant: Bank of America Corporation, Charlotte, NC (US)

(72) Inventors: Kapil Pruthi, Bothell, WA (US); Pavan Chayanam, Danville, CA (US); Andrew Keys, Albany, OR (US); Arul Arasu A Madavadiyan, Bainbridge Island, WA (US)

(73) Assignee: Bank of America Corporation, Charlotte, NC (US)

(21) Appl. No.: 14/262,021

(22) Filed: Apr. 25, 2014

(51) Int. Cl. H04L 29/06

(52) U.S. Cl. CPC H04L 63/0838

(57) ABSTRACT

A system for authenticating a mobile user's identity is disclosed. The user may be required to log in upon first launching a mobile application. Subsequent launches of the mobile application may not require the user to log in. Upon subsequently launching the mobile application, the mobile device may transmit a token validation request that includes a soft token stored at the mobile application. An authentication server may receive the request and transmit a one-time password to a device that has the phone number associated with the soft token. The authentication server may also transmit a session ID number. When the authentication server receives an identity validation response from the mobile device that includes the session ID number and the one-time password, the authentication server may output requested customer account information.

### TECHNICAL FIELD

Aspects of the disclosure relate generally to a system and method for authenticating a mobile user's identity. Specifically, aspects of the disclosure relate to an authentication server that authenticates a mobile user's identity using a session ID number and one-time password.

### BACKGROUND

The use of mobile applications to access secure information has become very common. This secure information may include financial information, such as account balances at a bank. Users want to ensure that their information is secure, but often also want to avoid the hassle of logging in with a username and password each time they want to view their account information. Logging in to a mobile application is both time-consuming and prone to errors such as mistyping log in information. Thus, there is a need for a method and system of allowing users to securely access information at their mobile devices without the need for providing log in information each time they launch the application.

### SUMMARY

The following presents a simplified summary of the present disclosure in order to provide a basic understanding of some aspects of the disclosure. This summary is not an extensive overview of the disclosure. It is not intended to identify key or critical elements of the disclosure or to delineate the scope of the disclosure. The following summary merely presents some concepts of the disclosure in a simplified form as a prelude to the more detailed description provided below.

Certain aspects disclose a method, comprising: receiving, at an authentication server, a token validation request, wherein the token validation request comprises a soft token stored at a mobile device; validating, at the authentication server, the soft token, wherein the validating comprises retrieving, from a database, customer data associated with the soft token; transmitting, at the authentication server, a one-time password and a session ID number; receiving, at the authentication server, an identity validation response; comparing, at the authentication server, the identity validation response with the one-time password and the session ID number to determine whether the identity validation response includes both the one-time password and the session ID number; and outputting, at the authentication server, account information.

Certain other aspects disclose a non-transitory computer-readable storage medium having computer-executable program instructions stored thereon that, when executed by a processor, cause the processor to: receive a token validation request, wherein the token validation request comprises a soft token stored at a mobile device; validate the soft token, wherein the validating comprises retrieving, from a database, customer data associated with the soft token; transmit a one-time password and a session ID number; receive an identity validation response; compare the identity validation response with the one-time password and the session ID number to determine whether the identity validation response includes both the one-time password and the session ID number; and output account information.

Certain other aspects disclose an apparatus comprising: a memory; a processor, wherein the processor executes computer-executable program instructions which cause the processor to: receive a token validation request, wherein the token validation request comprises a soft token stored at a mobile device; validate the soft token, wherein the validating comprises retrieving, from a database, customer data associated with the soft token; transmit a one-time password and a session ID number; receive an identity validation response; compare the identity validation response with the one-time password and the session ID number to determine whether the identity validation response includes both the one-time password and the session ID number; and output account information.

The details of these and other embodiments of the disclosure are set forth in the accompanying drawings and description below. Other features and advantages of aspects of the disclosure will be apparent from the description, drawings, and claims.

### BRIEF DESCRIPTION OF THE DRAWINGS

All descriptions are exemplary and explanatory only and are not intended to restrict the disclosure, as claimed. The accompanying drawings, which are incorporated in and constitute a part of this specification, illustrate embodiments of the disclosure and, together with the description, serve to explain principles of the disclosure. In the drawings:

FIG. 1 shows an illustrative operating environment in which various aspects of the disclosure may be implemented.

FIG. 2 shows an illustrative block diagram of network devices and server that may be used to implement the processes and function of one or more aspects of the present disclosure.

FIG. 3 shows an illustrative flow chart in accordance with aspects of the disclosure.

FIG. 4 shows an illustrative schematic diagram in accordance with aspects of the disclosure.

### DETAILED DESCRIPTION

In accordance with various aspects of the disclosure, methods, non-transitory computer-readable media, and apparatuses are disclosed for authenticating a user's identity. In certain aspects, when a server receives a request data from a computing device, the server processes and analyzes the request and provides the requested data. The automated process may utilize various hardware components (e.g., processors, communication servers, memory devices, and the like) and related computer algorithms to generate image data related to the agency's business data.

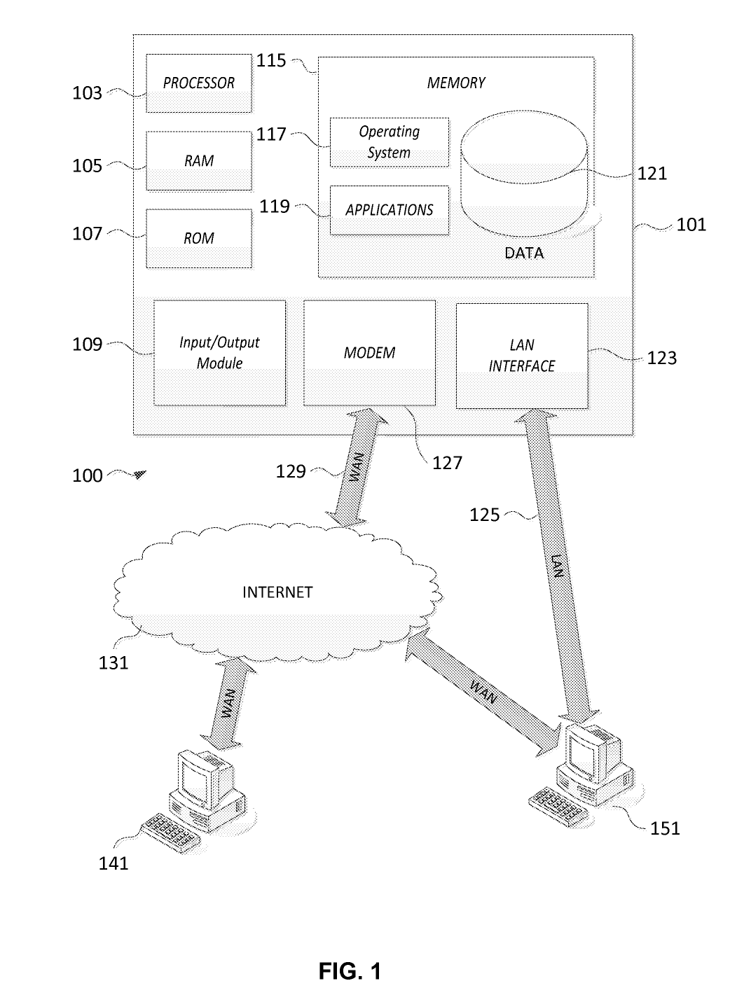

FIG. 1 illustrates an example of a suitable computing system environment 100 that may be used according to one or more illustrative embodiments. The computing system environment 100 is only one example of a suitable computing environment and is not intended to suggest any limitation as to the scope of use or functionality contained in the disclosure. The computing system environment 100 should not be interpreted as having any dependency or requirement relating to any one or combination of components shown in the illustrative computing system environment 100.

The disclosure is operational with numerous other general purpose or special purpose computing system environments or configurations. Examples of well-known computing systems, environments, and/or configurations that may be suitable for use with the disclosed embodiments include, but are not limited to, personal computers (PCs), server computers, hand-held or laptop devices, multiprocessor systems, microprocessor-based systems, set-top boxes, programmable consumer electronics, network PCs, minicomputers, mainframe computers, distributed computing environments that include any of the above systems or devices, and the like.

With reference to FIG. 1, the computing system environment 100 may include an authentication server 101 wherein the processes discussed herein may be implemented. The authentication server 101 may have a processor 103 for controlling the overall operation of the authentication server 101 and its associated components, including random-access memory (RAM) 105, read-only memory (ROM) 107, communications module 109, and memory 115. Processor 103 and its associated components may allow the authentication server 101 to run a series of computer-readable instructions related to receiving, storing, and analyzing data.

Authentication server 101 typically includes a variety of computer-readable media. Computer-readable media may be any available media that may be accessed by authentication server 101 and include both volatile and non-volatile media, removable and non-removable media. For example, computer-readable media may comprise a combination of computer storage media and communication media.

Computer storage media include volatile and non-volatile, removable and non-removable media implemented in any method or technology for storage of information such as computer-readable instructions, data structures, program modules, or other data. Computer storage media include, but are not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information that can be accessed by authentication server 101.

Computing system environment 100 may also include optical scanners (not shown). Exemplary usages include scanning and converting paper documents, such as correspondence, data, and the like to digital files.

Although not shown, RAM 105 may include one or more applications representing the application data stored in RAM 105 while the authentication server 101 is on and corresponding software applications (e.g., software tasks) are running on the authentication server 101.

Communications module 109 may include a microphone, keypad, touch screen, and/or stylus through which a user of authentication server 101 may provide input, and may also include one or more of a speaker for providing audio output and a video display device for providing textual, audiovisual and/or graphical output.

Software may be stored within memory 115 and/or storage to provide instructions to processor 103 for enabling authentication server 101 to perform various functions. For example, memory 115 may store software used by the authentication server 101, such as an operating system 117, application programs 119, and an associated database 121. In certain aspects, authentication server 101 may comprise a plurality of databases 121. Also, some or all of the computer executable instructions for authentication server 101 may be embodied in hardware or firmware.

Authentication server 101 may operate in a networked environment supporting connections to one or more remote computing devices, such as computing devices 141 and 151. The computing devices 141 and 151 may be personal computing devices or servers that include many or all of the elements described above relative to the authentication server 101.

The network connections depicted in FIG. 1 include a local area network (LAN) 125 and a wide area network (WAN) 129, but may also include other networks. When used in a LAN networking environment, authentication server 101 may be connected to the LAN 125 through a network interface or adapter in the communications module 109. When used in a WAN networking environment, the authentication server 101 may include a modem in the communications module 109 or other means for establishing communications over the WAN 129, such as the Internet 131 or other type of computer network. It will be appreciated that the network connections shown are illustrative and other means of establishing a communications link between the computing devices may be used. Various well-known protocols such as TCP/IP, Ethernet, FTP, HTTP and the like may be used, and the system may be operated in a client-server configuration to permit a user to retrieve web pages from a web-based server. Any of various conventional web browsers may be used to display and manipulate web pages.

Additionally, one or more application programs 119 used by the authentication server 101, according to an illustrative embodiment, may include computer executable instructions for invoking functionality related to communication including, for example, email short message service (SMS), and voice input and speech recognition applications. In addition, the application programs 119 may include computer executable instructions for invoking user functionality related to access a centralized repository for performing various service tasks like routing, logging, and protocol bridging.

Embodiments of the disclosure may include forms of computer-readable media. Computer-readable media include any available media that can be accessed by an authentication server 101. Computer-readable media may comprise storage media and communication media and in some examples may be non-transitory. Storage media include volatile and nonvolatile, removable and non-removable media implemented in any method or technology for storage of information such as computer-readable instructions, object code, data structures, program modules, or other data. Communication media include any information delivery media and typically embody data in a modulated data signal such as a carrier wave or other transport mechanism.

Various aspects described herein may be embodied as a method, a data processing system, or as a computer-readable medium storing computer-executable instructions. For example, a computer-readable medium storing instructions to cause a processor to perform steps of a method in accordance with aspects of the disclosed embodiments is contemplated. For instance, aspects of the method steps disclosed herein may be executed on a processor 103 on authentication server 101. Such a processor may execute computer-executable instructions stored on a computer-readable medium.

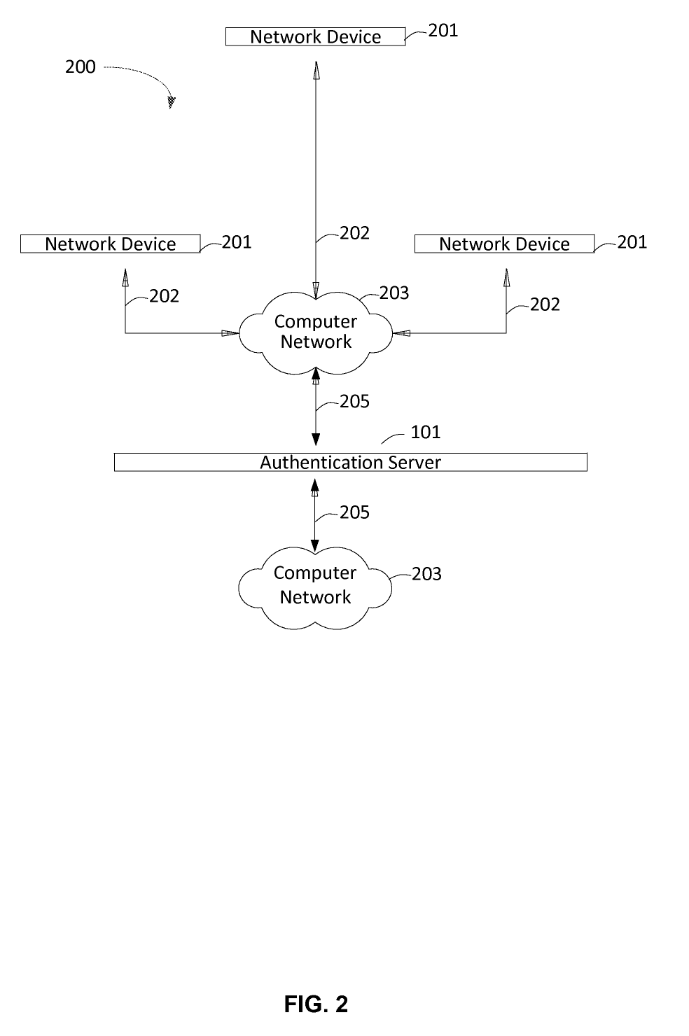

FIG. 2 illustrates another example operating environment in which various aspects of the disclosure may be implemented. As illustrated, system 200 may include one or more network devices 201. Network devices 201 may, in some examples, be connected by one or more communications links 202 to computer network 203 that may be linked via communications links 205 to server 204. In system 200, server 204 may be any suitable server, processor, computer, or data processing device, or combination of the same. Server 204 may be used to process the instructions received from, and the transactions entered into by, one or more participants.

According to one or more aspects, system 200 may be associated with a financial institution, such as a bank. Various elements may be located within the financial institution and/or may be located remotely from the financial institution. For instance, one or more network devices 201 may be located within a branch office of a financial institution. Such network devices may be used, for example, by customer service representatives, other employees, and/or customers of the financial institution in conducting financial transactions via network 203. Additionally or alternatively, one or more network devices 201 may be located at a user location (e.g., a customer's home or office). Such network devices also may be used, for example, by customers of the financial institution in conducting financial transactions via computer network 203. In some aspects, network devices 201 a server such as authentication server 101.

Computer network 203 may be any suitable computer network including the Internet, an intranet, a wide-area network (WAN), a local-area network (LAN), a wireless network, a digital subscriber line (DSL) network, a frame relay network, and asynchronous transfer mode network, a virtual private network (VPN), or any combination of any of the same. Communications links 202 and 205 may be any communications links suitable for communicating between network devices 201 and server 204, such as network links, dial-up links, wireless links, hard-wired links, and/or the like.

Having described an example of a computing device that can be used in implementing various aspects of the disclosure and an operating environment in which various aspects of the disclosure can be implemented, several embodiments will now be discussed in greater detail.

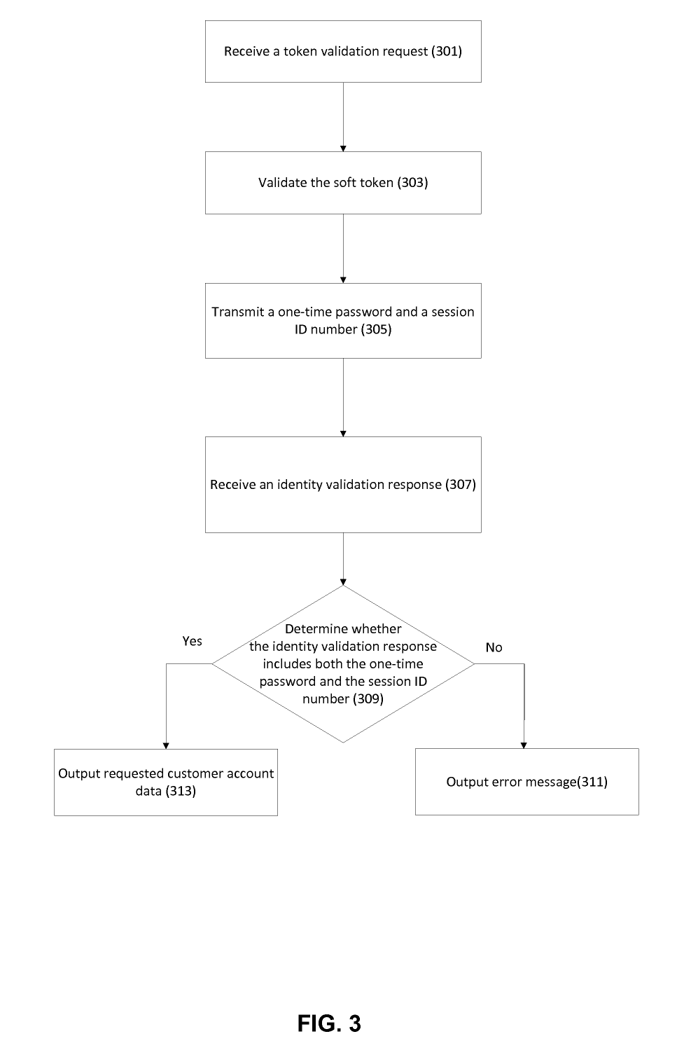

FIG. 3 illustrates an exemplary flow chart according to certain aspects of the disclosure. As described herein, a user may attempt to access information located at authentication server 101 using a mobile device such as computing device 141. For example, the user may be a customer of a financial institution, and may request access to account data via a mobile application stored at computing device 141. The mobile application may have been previously downloaded or placed in the computing device 141 using well-known methods. The mobile application may enable the customer view requested account data, such as account balance, account overview, and the like. A user (such as a financial institution customer) may launch the mobile application stored at a mobile computing device 141 (such as a cellular phone) and request to view his/her financial customer account data at the computing device 141. FIG. 3 illustrates an exemplary process for authenticating the user to verify that the request is a valid request without requiring that the user log in. The process shown in FIG. 3 may also be used to prevent token theft and man-in-the-middle attacks.

Prior to step 301 shown in FIG. 3, a user may be required to provide log in information at the mobile application. The log in information may comprise at least one of a username, password, challenge question and response, and the like. In some aspects, the user may be required to provide this log in information upon launching the mobile application for the first time. Subsequent uses of the mobile application may not require user log in information to retrieve data from authentication server 101. If the user provides invalid log in information, authentication server 101 may transmit a response indicating that the log in information is invalid. Authentication server 101 may further deny access to the customer account data.

If the authentication server 101 determines that the log in information is valid, authentication server 101 may generate a token, such as a soft token. The token may uniquely and persistently identify the customer. In certain aspects, authentication server 101 may store a soft token at the mobile application located at mobile computing device 141. The authentication server 101 may also store soft token information at memory 115, for example, at database 121. Therefore, database 121 may store the soft token information along with the corresponding customer data. The customer data may comprise at least one of the following information identifying a customer: customer name, telephone number of the mobile computing device 141 that transmitted the log in information, customer account number, and the like. Thus, authentication server 101 may be able to identify a customer's data based on a corresponding soft token.

After authentication server 101 receives the customer's log in information, it may transmit the unique soft token to the mobile computing device 141, where it may be stored at the mobile application. In certain aspects, authentication server 101 may then transmit a prompt that may be displayed at the mobile application. The prompt may enable the user to enter whether or not a pin number must be entered for future requests for account data at the mobile application. In other words, the prompt may ask the user whether he/she prefers that future attempts to access customer account data require entry of a pin number or automatically without further log in information or pin number requirements. The customer may respond to the prompt at the mobile application by enabling the pin option. At that point, the mobile application may prompt the user to select and enter a pin number. In some aspects, the pin number may comprise a previously selected pin number. Regardless, the authentication server 101 may receive the selected pin number entered by the customer, and store the pin number in database 121. The mobile application may then prompt the user for the pin number in response to all subsequent requests to access customer account data. In some aspects, the user may disable the pin option at the mobile application, at which point the mobile application may display customer account data upon request without requiring entry of the pin number.

FIG. 3 displays a process for authenticating a user and outputting customer account data. The process may begin at step 301. Step 301 may occur when a user launches the mobile application stored in computing device 141. As explained above, the user will have already provided his/her log in information, and authentication server 101 will have created a soft token and stored it at the mobile application. Prior to step 301, the user has also selected whether or not the pin option is enabled for subsequent uses of the mobile application. Step 301 may illustrate the internal process occurring during one of those subsequent uses.

Step 301 may occur when a user launches the mobile application at mobile computing device 141. When the user launches the mobile application, the mobile application may retrieve the soft token previously received from authentication server 101. Mobile computing device 141 may transmit the soft token in a token validation request. At step 301, authentication server 101 may receive the token validation request, which may comprise the soft token. If the user has enabled the pin option, the token validation request may also comprise the user's entered pin number.

At step 303, authentication server 101 may validate the soft token against its repository of information stored at database 121. At step 303, authentication server 101 may compare the soft token received at step 301 with soft tokens stored at database 121 to ensure that the soft token is valid and accounted for at the authentication server 101. If authentication server 101 is unable to locate a soft token matching the soft token received at step 301, authentication server 101 may output an error message. An error message may comprise at least one of a message displayed at the mobile application indicating that the request was denied, requiring the user to provide log in information, restarting the mobile application, and the like. If the user previously enabled the pin option, authentication server 101 may further, at step 303, validate the pin by comparing the received pin number with the pin number for the customer stored at database 12.

In addition to comparing the soft token (and the pin number, if enabled) with information stored at database 121, authentication server 101 may also at step 303 retrieve customer data associated with the soft token. The customer data may be stored at database 121 and may comprise the customer's name, telephone number of the mobile computing device 141 that transmitted the log in information, customer account number, and the like. In some aspects, the customer data may be stored at a location external to authentication server 101.

At step 305, authentication server 101 may transmit a one-time password and a session ID number to the mobile computing device 141. According to aspects of the disclosure, authentication server 101 may first transmit the one-time password to the computing device 141, and then later transmit the session ID number to the computing device 141. The one-time password may be generated at authentication server 101. The one-time password may comprise a randomly generated string that is only valid for the session in which it was created. Authentication server 101 may transmit the one-time password on a separate channel than the channel it uses for all other communication with the mobile application. For instance, authentication server 101 may receive a token validation request 301 at a first channel and may transmit the one-time password on a second channel. All other communications between the mobile application and authentication server 101 may take place at the first channel.

In some aspects, authentication server 101 may transmit the one-time password to the device with the phone number retrieved at step 303. In certain aspects, the device with the phone number retrieved at step 303 may be the same device that transmitted the token validation request at step 301 (for example, mobile computing device 141). In some cases, there may be an attempted token theft. An individual may extract the soft token stored at the mobile application and send a token validation request from another device in an effort to view a customer's account data. However, authentication server 101 at step 305 transmits a one-time password to the device with the phone number retrieved at step 303 (here, the customer's device). Authentication server 101 will not send the one-time password to another device (here, the device in which token theft is attempted). Thus, the thief using the device to send a token validation request will not receive the one-time password at that device.

Authentication server 101 may transmit the one-time password to the mobile computing device 141 (such as a mobile phone) via a push notification, assuming the mobile computing device 141 has the associated phone number associated with soft token at database 121. The push notification may comprise a short messaging service (SMS) that may be read by the mobile application.

After transmitting the one-time password via a second channel (such as a push notification), authentication server 101 may transmit a session ID number at step 305. The session ID number may be generated at authentication server 101 and transmitted to the mobile application on the first channel from which the authentication server 101 received the token validation request at step 301. Thus, at step 305, authentication server 101 may transmit a one-time password to the mobile phone that has the telephone number associated with the soft token received at step 301, and then transmit a session ID number directly to the mobile application that transmitted the token validation request. The use of these two mechanisms in authenticating the customer may protect the customer from token theft and man-in-the-middle attacks, while also removing the hassle of logging into the mobile application to view account data.

After the mobile application receives the one-time password and the session ID number, the mobile application may generate an identity validation response. The identity validation response may comprise the session ID number and the one-time password received at step 305. The mobile application may transmit the identity validation response and the authentication server 101 may receive the identity validation response at step 307. In some aspects, such as attempted use of the soft token at an unauthorized device, the identity validation response may not comprise at least one of the session ID number and the one-time password. For instance, an unauthorized device will not receive the one-time password, so it will be unable to include the one-time password in an identity validation response at step 307.

At step 309, authentication server 101 may compare the identity validation response with the one-time password and session ID number created for the session to determine whether the identity response includes both the one-time password and the session ID number. If either the session ID number or the one-time password is missing or inaccurate, authentication server 101 may output an error message at step 311. An error message may comprise at least one of a message displayed at the mobile application indicating that the request was denied, requiring the user to provide log in information, restarting the mobile application, and the like. In some aspects, authentication server 101 may output an error message if it does not receive an identity validation response at step 307. If the pin option is enabled, authentication server 101 may output the error message if the received pin number is inaccurate.

At step 313, authentication server 101 may output the requested customer account data. Step 313 may occur after the authentication determines at step 309 that the identity validation response includes both the one-time password and the session ID number. The customer account data may comprise read-only financial institution information such as the customer's account balance, the customer's account summary, and the like. Authentication server 101 may output account information which may comprise the customer account data or an error message.

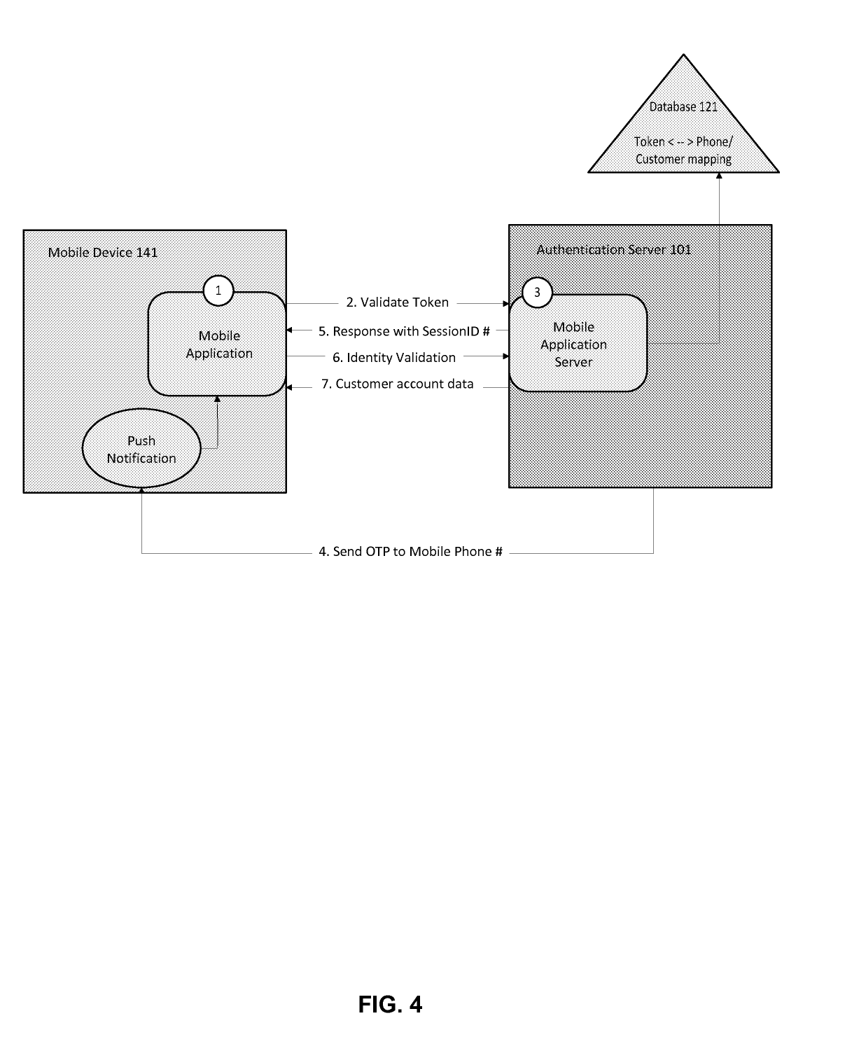

FIG. 4 illustrates an exemplary schematic diagram of the process shown in FIG. 3. As shown in FIG. 4, the process for authenticating a mobile user may comprise seven steps. At step 1 of FIG. 4, the mobile application may pull a soft token and other mobile attributes from the mobile device 141. At step 2, the mobile application may send a token validation request to the authentication server 101. If the user has enabled the pin option, a pin number may be sent along with the validation request at step 2. At step 3, authentication server 101 may validate the soft token (and pin, if enabled) against its repository. Authentication server 101 may also pull the phone number and customer data associated with that token from database 121. Before returning the token validation response to the client, authentication server 101 may trigger a separate notification to the mobile phone number at step 4. The notification may comprise a one-time password. At step 5, the authentication server may return a token validation response that includes a short-lived session ID number. The mobile application may then gather the session ID number received at step 5, and the one-time password received from the push notification at step 4. At step 6, the mobile application may send an identity validation request comprising the one-time password and session ID number to the authentication server 101. At step 7, authentication server 101 may perform caller identity validation by validating the session ID number and one-time password received at step 6. If the caller identity is confirmed, authentication server 101 may output the customer's data (such as account balance information).

The foregoing descriptions of the disclosure have been presented for purposes of illustration and description. They are not exhaustive and do not limit the disclosure to the precise form disclosed. Modifications and variations are possible in light of the above teachings or may be acquired from practicing of the disclosure. For example, the described implementation includes software by the present disclosure may be implemented as a combination of hardware and software or in hardware alone. Additionally, although aspects of the present disclosure are described as being stored in memory, one skilled in the art will appreciate that these aspects can also be stored on other types of computer-readable media, such as secondary storage devices, like hard disks, floppy disks, or CD-ROM.

What is claimed is:

1. A method, comprising:
receiving, at an authentication server, a token validation request, wherein the token validation request comprises a soft token stored at a mobile device;
validating, at the authentication server, the soft token, wherein the validating comprises retrieving, from a database, customer data associated with the soft token;
transmitting, at the authentication server, a one-time password and a session ID number;
receiving, at the authentication server, an identity validation response;
comparing, at the authentication server, the identity validation response with the one-time password and the session ID number to determine whether the identity validation response includes both the one-time password and the session ID number; and
outputting, at the authentication server, account information.

2. The method of claim 1, wherein the account information comprises requested customer account data if the identity validation response includes both the one-time password and the session ID number.

3. The method of claim 1, wherein the account information comprises an error message if the identity validation response includes both the one-time password and the session ID number.

4. The method of claim 1, wherein the token validation request comprises a pin number and wherein the validating further comprises comparing the pin number to a pin number stored in the database.

5. The method of claim 1, wherein the transmitting comprises sending the one-time password via a push notification.

6. The method of claim 1, wherein the transmitting is performed on a separate channel than the receiving.

7. The method of claim 1, wherein the customer data comprises a customer phone number and other information identifying a customer.

8. A non-transitory computer-readable storage medium having computer-executable program instructions stored thereon that, when executed by a processor, cause the processor to:
receive a token validation request, wherein the token validation request comprises a soft token stored at a mobile device;
validate the soft token, wherein the validating comprises retrieving, from a database, customer data associated with the soft token;
transmit a one-time password and a session ID number;
receive an identity validation response;
compare the identity validation response with the one-time password and the session ID number to determine whether the identity validation response includes both the one-time password and the session ID number; and
output account information.

9. The non-transitory computer-readable storage medium of claim 8, wherein the account information comprises requested customer account data if the identity validation response includes both the one-time password and the session ID number.

10. The transitory computer-readable storage medium of claim 8, wherein the account information comprises an error message if the identity validation response includes both the one-time password and the session ID number.

11. The transitory computer-readable storage medium of claim 8, wherein the token validation request comprises a pin number and wherein the validating further comprises comparing the pin number to a pin number stored in the database.

12. The transitory computer-readable storage medium of claim 8, wherein the transmitting comprises sending the one-time password via a push notification.

13. The transitory computer-readable storage medium of claim 8, wherein the transmitting is performed on a separate channel than the receiving.

14. An apparatus comprising:
a memory;
a processor, wherein the processor executes computer-executable program instructions which cause the processor to:
receive a token validation request, wherein the token validation request comprises a soft token stored at a mobile device;
validate the soft token, wherein the validating comprises retrieving, from a database, customer data associated with the soft token;
transmit a one-time password and a session ID number;
receive an identity validation response;
compare the identity validation response with the one-time password and the session ID number to determine whether the identity validation response includes both the one-time password and the session ID number; and
output account information.

15. The apparatus of claim 14, wherein the account information comprises requested customer account data if the identity validation response includes both the one-time password and the session ID number.

16. The apparatus of claim 14, wherein the account information comprises an error message if the identity validation response includes both the one-time password and the session ID number.

17. The apparatus of claim 14, wherein the token validation request comprises a pin number and wherein the validating further comprises comparing the pin number to a pin number stored in the database.

18. The apparatus of claim 14, wherein the transmitting comprises sending the one-time password via a push notification.

19. The apparatus of claim 14, wherein the transmitting is performed on a separate channel than the receiving.

20. The apparatus of claim 14, wherein the customer data comprises a customer phone number and other information identifying a customer.
